(19) United States
(12) Patent Application Publication
(10) Pub. No.: US 2026/0253504 A1
(43) Pub. Date: Aug. 27, 2026

(54) INFORMATION PROVISION DEVICE, FLYING BODY AND INFORMATION PROVISION METHOD

(71) Applicant: NEC CORPORATION, Minato-ku, Tokyo (JP)

(72) Inventors: Takanari ARAI, Tokyo (JP); Eiichi TOKUMI, Tokyo (JP); Kenichi Keyaki, Tokyo (JP); Eiji ICHIHARA, Tokyo (JP); Kensuke UCHIDA, Tokyo (JP); Jun Suzuki, Tokyo (JP); Kenichi Sakamoto, Tokyo (JP); Takeshi Shouta, Tokyo (JP)

(73) Assignee: NEC CORPORATION, Minato-ku, Tokyo (JP)

(21) Appl. No.: 18/726,150

(22) PCT Filed: Jan. 28, 2022
(86) PCT No.: PCT/JP2022/003226

§ 371 Date: Jul. 2, 2024

(51) Int. Cl. G08G 5/72; G08B 21/18

(52) U.S. Cl. CPC G08G 5/72; G08B 21/18

(57) ABSTRACT

An information provision device according to an aspect of the present disclosure includes: at least one memory storing a set of instructions; and at least one processor configured to execute the set of instructions to: determine whether a flying body is in a predetermined area based on measurement data of the flying body measured by a sensor; determine whether a signal is received from the flying body that has been determined to be in the predetermined area, the signal having a predetermined pattern associated with a mission in the predetermined area; determine, if no signal having the predetermined pattern is received from the flying body, that the flying body is an unauthorized flying body that is not permitted to enter the predetermined area; and notify a predetermined notification destination of information including the position of the unauthorized flying body.

### TECHNICAL FIELD

The present disclosure relates to a technique for providing information, and particularly to a technique for providing information on a flying body.

### BACKGROUND ART

In recent years, flying bodies such as drones have become easily available, and those flying bodies have come to be frequently used. However, in a case where a flying body whose entry is not permitted enters a place where some mission by a flying body is executed, such as a disaster site, some danger may arise and the execution of the mission may be hindered.

PTL 1 discloses a management system that performs control according to attribute information of a current position of an autonomous mobile body and individual information of the autonomous mobile body when a moving route of the autonomous mobile body is changed from a plan.

PTL 2 describes a computer system that supervise a flight of a flight vehicle in a three-dimensional space network based on area data including dynamic information indicating the three-dimensional space network and a dynamically changing situation of the three-dimensional space network.

PTL 3 describes a flight system including an output unit that outputs a prohibition signal indicating that flight is prohibited or emits prescribed irradiation light to a flight prohibited area, and a flight vehicle that performs a hovering operation or a landing operation when receiving the prohibition signal or the prescribed irradiation light.

PTL 4 describes a flight management device that transmits warning information to a vehicle at a position relevant to position information when receiving, from the flight device, position information of a flight device and notification information indicating that the flight device is likely to fall.

PTL 5 describes a system that determines whether an identifier indicated by a signal transmitted from a flight system is an identifier of a flight system permitted to fly in the airspace. The system functions to interact with elements, interfering, removing, or other methods when the flight system is an unauthorized flight system.

### CITATION LIST

### Patent Literature

PTL 1: WO 2019/181897 A1

PTL 2: JP 2020-087145 A

PTL 3: JP 2020-001651 A

PTL 4: WO 2019/176423 A

PTL 5: JP 2019-517083 W

### SUMMARY OF INVENTION

### Technical Problem

The techniques of PTLs 1 to 3 are techniques for controlling or supervising a flying body under management. The technique of PTL 4 is a technique for notifying an abnormality of a flying body under control. In the techniques of PTLs 1 to 4, it is not possible to obtain information on a flying body that is not under control. The technique of PTL 5 can determine whether a flying body that transmits an identifier is a flying body permitted to fly in the airspace. In the technique of PTL 5, for example, in a case where the flying body whose flight has been permitted cannot transmit an identifier, it cannot be determined that the flying body is the flying body whose flight has been permitted.

One object of the present disclosure is to provide an information provision device or the like capable of providing information on a flying body that is not permitted to enter a prescribed area regardless of whether a signal indicating an identifier transmitted by the flying body can be received.

### Solution to Problem

An information provision device according to one aspect of the present disclosure includes a position determination means for determining whether a flying body is in a prescribed area based on measurement data of the flying body measured by a sensor, a specific information determination means for determining whether a signal having a prescribed pattern associated with a mission in the prescribed area is received from the flying body that has been determined to be in the prescribed area, a permission determination means for determining, if no signal having the prescribed pattern is received from the flying body, that the flying body is an unauthorized flying body that is not permitted to enter the prescribed area, and a notification means for notifying a prescribed notification destination of information including the position of the unauthorized flying body.

A flying body according to one aspect of the present disclosure includes a specific signal transmission means for emitting a specific signal having a prescribed pattern, the specific signal being associated with a mission in a prescribed area.

An information provision method according to one aspect of the present disclosure includes determining whether a flying body is in a prescribed area based on measurement data of the flying body measured by a sensor, determining whether a signal having a prescribed pattern associated with a mission in the prescribed area is received from the flying body that has been determined to be in the prescribed area, determining, if no signal having the prescribed pattern is received from the flying body, that the flying body is an unauthorized flying body that is not permitted to enter the prescribed area, and notifying a prescribed notification destination of information including a position of the unauthorized flying body.

A storage medium according to one aspect of the present disclosure stores a program for causing a computer to execute a process including a position determination process for determining whether a flying body is in a prescribed area based on measurement data of the flying body measured by a sensor, a specific information determination process for determining whether a signal having a prescribed pattern associated with a mission in the prescribed area is received from the flying body that has been determined to be in the prescribed area, a permission determination process for determining, if no signal having the prescribed pattern is received from the flying body, that the flying body is an unauthorized flying body that is not permitted to enter the prescribed area, and a notification process for notifying a prescribed notification destination of information including the position of the unauthorized flying body. One aspect of the present disclosure is also implemented by the program described above.

### Advantageous Effects of Invention

The present disclosure has an effect of providing information of a flying body that is not permitted to enter a prescribed area regardless of whether a signal indicating an identifier transmitted by the flying body can be received.

### BRIEF DESCRIPTION OF DRAWINGS

FIG. 1 is a block diagram illustrating an example of a configuration of an information provision device according to a first example embodiment of the present disclosure.

FIG. 2 is a flowchart illustrating an example of the operation of the information provision device according to the first example embodiment of the present disclosure.

FIG. 3 is a block diagram illustrating an example of a configuration of an information provision device according to a second example embodiment of the present disclosure.

FIG. 4 is a flowchart illustrating an example of the entire operation of the information provision device according to the second example embodiment of the present disclosure.

FIG. 5 is a flowchart illustrating an example of an operation of a detection process of the information provision device according to the second example embodiment of the present disclosure.

FIG. 6 is a flowchart illustrating an operation of a determination process of the information provision device according to the second example embodiment of the present disclosure.

FIG. 7 is a block diagram illustrating an example of a configuration of a flying body according to a third example embodiment of the present disclosure.

FIG. 8 is a flowchart illustrating an example of the operation of the flying body according to the third example embodiment of the present disclosure.

FIG. 9 is a block diagram illustrating an example of a configuration of a flying body according to a modification of the third example embodiment of the present disclosure.

FIG. 10 is a flowchart illustrating an example of the operation of the flying body according to the modification of the third example embodiment of the present disclosure.

FIG. 11 is a diagram illustrating an example of a hardware configuration of a computer that can implement the information provision device according to the example embodiments of the present disclosure.

FIG. 12 is a diagram schematically illustrating an annular possible existence range of the flying body.

FIG. 13 is a diagram illustrating an example of a notification image in which marks are superimposed.

FIG. 14 is a diagram illustrating an example of the shape of the reflection portion.

### EXAMPLE EXAMPLES

Hereinafter, example embodiments of the present disclosure will be described in detail with reference to the drawings.

### First Example Embodiment

First, a first example embodiment of the present disclosure will be described in detail with reference to the drawings.

### Configuration

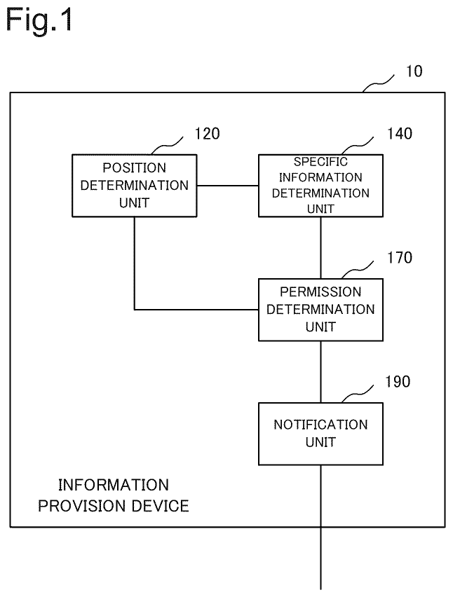

FIG. 1 is a block diagram illustrating an example of a configuration of an information provision device 10 according to the first example embodiment of the present disclosure. In the example illustrated in FIG. 1, the information provision device 10 according to the present example embodiment includes a position determination unit 120, a specific information determination unit 140, a permission determination unit 170, and a notification unit 190. The position determination unit 120 determines whether a flying body is in a prescribed area based on measurement data of the flying body measured by a sensor. The specific information determination unit 140 determines whether a signal having a prescribed pattern assigned to a mission in the prescribed area is received from the flying body which has been determined to be in the prescribed area. If no signal having the prescribed pattern is received from the flying body, the permission determination unit 170 determines that the flying body is an unauthorized flying body that is not permitted to enter the prescribed area. The notification unit 190 notifies a prescribed notification destination of information including the position of the unauthorized flying body.

The prescribed area is, for example, above an area where a disaster has occurred. For example, an administrator of the prescribed area permits a flying body performing a mission in the prescribed area to enter the prescribed area. The height of the prescribed area may be appropriately determined.

The sensor according to the present example embodiment is, for example, a plurality of imaging devices installed so as to be able to image a flying body flying in the prescribed area described above. The positions of the plurality of imaging devices, the directions of the optical axes, the camera parameters, and the like are obtained in advance by measurement, calibration, and the like. The positions of the imaging devices, the directions of the optical axes, and the like may be determined in a coordinate system appropriately defined in advance in the three-dimensional space. The positions of the imaging devices may be represented by latitude, longitude, and height from the sea surface.

According to the present example embodiment, a flying body to which a mission in a prescribed area is assigned and which is permitted to enter the prescribed area is configured to emit a signal having a prescribed pattern (hereinafter, also referred to as a specific signal). The signal having the prescribed pattern is a signal different from the signal indicating the identifier of the flying body. The specific signal may be, for example, light blinking in a specific pattern emitted by a light emitting element such as a light emitting diode (LED) attached to the flying body. Another example of the signal having the prescribed pattern will be described in detail later.

### Position Determination Unit 120

The position determination unit 120 detects a flying body based on the measurement data of the flying body measured by the sensor, for example, a plurality of captured images obtained by the plurality of imaging devices described above. Specifically, the measurement data used by the position determination unit 120 is images captured at the same timing by at least two imaging devices. These images may be images included in moving images. The method for detecting the flying body may be any of existing image recognition methods. The position determination unit 120 estimates the position of the detected flying body. The method of estimating the position of the detected flying body may be one of various existing methods, for example, a method of estimating a three-dimensional position of a point in an image from an image captured by a stereo camera.

### Specific Information Determination Unit 140

The specific information determination unit 140 determines whether a signal (that is, the above-described specific signal) having a prescribed pattern associated with the mission in the prescribed area has been received from the flying body determined to be in the prescribed area, using the measurement data of the flying body. In a case where the specific signal is light blinking in a specific pattern emitted by the light emitting element attached to the flying body, the measurement data used by the specific information determination unit 140 is, for example, a moving image of the flying body determined to be in the prescribed area, captured by the imaging device. The imaging device that captures the moving image may be one of the plurality of imaging devices described above. The imaging device that captures the moving image may be an imaging device different from the plurality of imaging devices described above. The imaging device that captures the moving image may be, for example, an imaging device configured to track the flying body determined to be in the prescribed area. The method of tracking the flying body may be one of various existing methods.

The specific information determination unit 140 may detect a region of blinking light in the moving image of the flying body determined to be in the prescribed area, and determine whether the pattern of the blinking light is a specific pattern in the detected region.

### Permission Determination Unit 170

In a case where no signal having the prescribed pattern is received from the flying body determined to be in the prescribed area, the permission determination unit 170 determines that the flying body is an unauthorized flying body that is a flying body not permitted to enter the prescribed area. For example, in a case where a region where light blinks in a specific pattern is not detected in the moving image of the flying body determined to be in the prescribed area, the permission determination unit 170 determines that the flying body is an unauthorized flying body.

In a case where a signal having a prescribed pattern is received from the flying body determined to be in the prescribed area, the permission determination unit 170 may determine that the flying body is an authorized flying body permitted to enter the prescribed area. For example, in a case where a region in which light blinks in a specific pattern is detected in the moving image of the flying body determined to be in the prescribed area, the permission determination unit 170 may determine that the flying body is an authorized flying body.

### Notification Unit 190

The notification unit 190 notifies a prescribed notification destination (for example, a notification destination device) of information including the position of the unauthorized flying body. The information including the position of the unauthorized flying body may include information indicating that the unauthorized flying body has entered the prescribed area. The information including the position of the unauthorized flying body may include information indicating the position of the unauthorized flying body in the prescribed area. The information indicating the position of the unauthorized flying body may be, for example, an image in which a mark indicating the position of the unauthorized flying body is superimposed on a ground map of the prescribed area. The information indicating the position of the flying body may be an image in which a mark indicating the position of the unauthorized flying body is superimposed on an image of the flying body captured by the imaging device (for example, a still image or a moving image).

The notification destination device may be, for example, a terminal device managed by an administrator of the information provision device 10. The notification destination device may be, for example, a terminal device managed by a worker who is performing work using a flying body in a prescribed area.

### Operation

Next, an operation of the information provision device 10 according to the first example embodiment of the present disclosure will be described in detail with reference to the drawings.

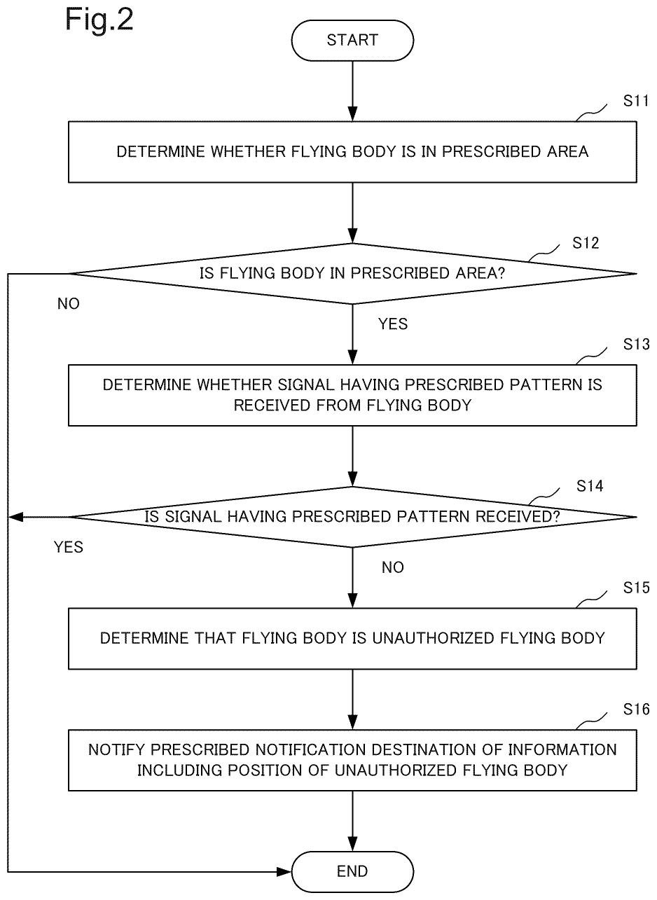

FIG. 2 is a flowchart illustrating an example of the operation of the information provision device 10 according to the first example embodiment of the present disclosure. In the example illustrated in FIG. 2, first, the position determination unit 120 determines whether a flying body is in the prescribed area based on the measurement data of the flying body (step S11). In a case where the flying body is not in the prescribed area (NO in step S12), the operation of the information provision device 10 of the present example embodiment ends. In a case where the flying body is in the prescribed area (YES in step S12), the specific information determination unit 140 determines whether a signal having a prescribed pattern has been received from the flying body (step S13). In a case where the signal of the prescribed pattern is received from the flying body (YES in step S14), the information provision device 10 of the present example embodiment ends the operation illustrated in FIG. 2. In a case where the signal having the prescribed pattern is not received from the flying body (NO in step S14), the permission determination unit 170 determines that the flying body is an unauthorized flying body (step S15). Then, the notification unit 190 notifies the prescribed notification destination of information including the position of the unauthorized flying body (step S16).

### Effects

The present example embodiment has an effect of providing information of a flying body that is not permitted to enter a prescribed area regardless of whether a signal indicating an identifier transmitted by the flying body can be received. This is because the specific information determination unit 140 determines whether a signal having a prescribed pattern associated with the mission in the prescribed area has been received from the flying body that is determined to be in the prescribed area. Then, this is because the permission determination unit 170 determines that the flying body is an unauthorized flying body that is not permitted to enter the prescribed area in a case where the signal having the prescribed pattern is not received from the flying body. In addition, this is because the notification unit 190 notifies the information on the unauthorized flying body.

### Second Example Embodiment

Next, a second example embodiment of the present disclosure will be described in detail with reference to the drawings.

### Configuration

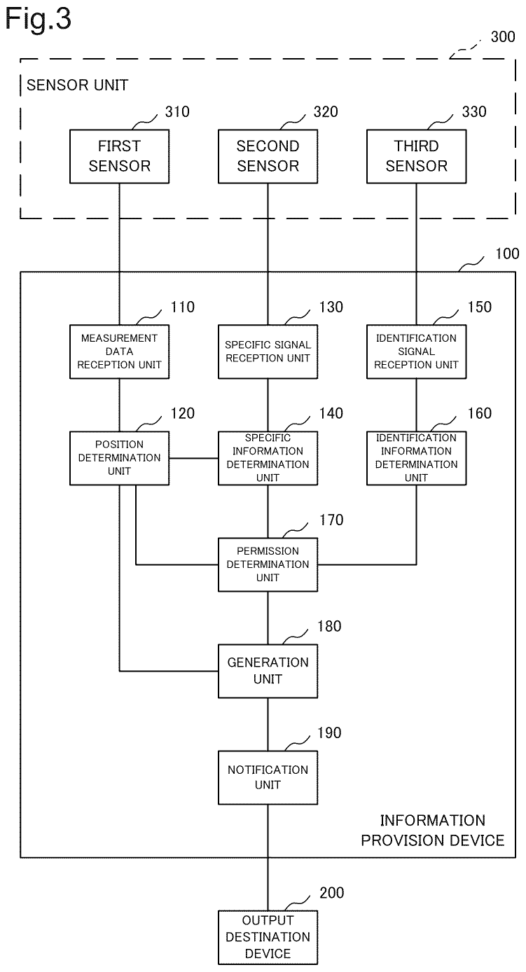

FIG. 3 is a block diagram illustrating an example of a configuration of an information provision device 100 according to the second example embodiment of the present disclosure. In the example illustrated in FIG. 3, the information provision device 100 includes a measurement data reception unit 110, a position determination unit 120, a specific signal reception unit 130, a specific information determination unit 140, an identification signal reception unit 150, an identification information determination unit 160, a permission determination unit 170, a generation unit 180, and a notification unit 190. The information provision device 100 is communicably connected to a first sensor 310, a second sensor 320, and a third sensor 330. The first sensor 310, the second sensor 320, and the third sensor 330 are also collectively referred to as a sensor unit 300. The information provision device 100 is further communicably connected to the notification destination device 200. Among the components of the present example embodiment, the same components as those of the first example embodiment are given the same names and reference numerals as those given to the components of the first example embodiment.

In the following description, the prescribed area is the same as the prescribed area of the first example embodiment. In other words, the prescribed area is, for example, above an area where a disaster has occurred. For example, an administrator of the prescribed area permits a flying body performing a mission in the prescribed area to enter the prescribed area. The height of the prescribed area may be appropriately determined.

Also in the present example embodiment, a flying body to which a mission in the prescribed area is assigned and which is permitted to enter the prescribed area is configured to emit a signal having a prescribed pattern (that is, the specific signal). As described above, the signal having the prescribed pattern is a signal different from the signal indicating the identifier of the flying body. As described above, the specific signal may be, for example, light blinking in a specific pattern emitted by a light emitting element such as an LED attached to the flying body.

According to the present example embodiment, at least a part of the flying body wirelessly transmits an identification signal indicating identification information given to each flying body. A mechanism for wirelessly transmitting an identification signal indicating identification information is generally called remote identification (ID).

### Sensor Unit 300

### First Sensor 310

The first sensor 310 is relevant to the sensor of the first example embodiment. In other words, the first sensor 310 is, for example, a plurality of imaging devices installed so as to be able to image a flying body flying in the prescribed area described above. The plurality of imaging devices as the first sensor 310 may be configured to capture images at the same timing. The plurality of imaging devices as the first sensor 310 may be configured to capture a moving image.

### Second Sensor 320

According to the present example embodiment, the second sensor 320 captures a moving image of the flying body. The second sensor 320 may be the same imaging device as the first sensor 310. The second sensor 320 may be an imaging device different from the first sensor 310. Each of the imaging devices as the second sensor 320 may be configured to track one of the imaging devices placed in the prescribed area.

### Third Sensor 330

The third sensor 330 is a sensor that receives an identification signal indicating identification information of the flying body while the identification signal is wirelessly transmitted from the flying body. There may be a plurality of third sensors installed in the prescribed area. The position where the third sensor is installed may be measured in advance and given to the information provision device 100.

### Information Provision Device 100

### Measurement Data Reception unit 110

The measurement data reception unit 110 receives, from the first sensor 310, the measurement data (the images captured by the plurality of imaging devices at the same timing, as described above) measured by the first sensor 310. The measurement data reception unit 110 sends the received measurement data to the position determination unit 120.

### Position Determination Unit 120

The position determination unit 120 receives the measurement data from the measurement data reception unit 110. The position determination unit 120 estimates the position of the flying body using the measurement data, as in the position determination unit 120 according to the first example embodiment. The position determination unit 120 determines whether the estimated position of the flying body is included in the prescribed area. The position determination unit 120 transmits, to the permission determination unit 170, the estimated position (specifically, information indicating the position) of the flying body that is determined to be in the prescribed area.

The position determination unit 120 further transmits, to the specific information determination unit 140, the information indicating the flying body that is determined to be in the prescribed area. The information indicating the flying body determined to be in the prescribed area includes information indicating an estimated position of the flying body. In a case where the first sensor 310 is the same imaging device as the second sensor 320, the information indicating the flying body determined to be in the prescribed area may include information indicating a region of the flying body in the image in which the flying body is captured.

### Specific Signal Reception Unit 130

The specific signal reception unit 130 receives, from the second sensor 320, measurement data (specifically, for example, a moving image) of the flying body in the prescribed area, which is captured by the second sensor 320. The specific signal reception unit 130 sends the received moving image to the specific information determination unit 140.

### Specific Information Determination Unit 140

The specific information determination unit 140 receives, from the specific signal reception unit 130, the moving image of the flying body in the prescribed area. The specific information determination unit 140 further receives, from the position determination unit 120, information indicating the flying body determined to be in the prescribed area. The specific information determination unit 140 specifies the flying body determined to be in the prescribed area in the received moving image from the received information indicating the flying body determined to be in the prescribed area. In a case where the information indicating the flying body determined to be in the prescribed area is information indicating the position of the flying body, the specific information determination unit 140 specifies the flying body determined to be in the prescribed area in the received moving image from the position of the flying body and the information indicating the imaging range of the second sensor 320. In a case where the first sensor 310 is the same imaging device as the second sensor 320, and the information indicating the flying body determined to be in the prescribed area is the information indicating the region of the flying body in the captured image, the specific information determination unit 140 uses the received information indicating the region of the flying body as it is.

The specific information determination unit 140 determines whether a signal having a prescribed pattern is emitted from the flying body in the prescribed area. As described above, according to the present example embodiment, the signal having the prescribed pattern, that is, the specific signal is light blinking in the prescribed pattern emitted by the light emitting element. For example, the specific information determination unit 140 may track the region of the flying body in the moving image of the flying body. Then, the specific information determination unit 140 may detect a partial region that blinks in a prescribed pattern in the region of the flying body being tracked. In a case where a partial region blinking in a prescribed pattern is detected in the region of the flying body being tracked, the specific information determination unit 140 may determine that a signal having a prescribed pattern is emitted from the flying body. The specific information determination unit 140 transmits, to the permission determination unit 170, information on the position of the flying body determined to have emitted a signal having the prescribed pattern and information on the position of the flying body determined not to have emitted a signal having the prescribed pattern.

### Identification Signal Reception Unit 150

The identification signal reception unit 150 receives, from the third sensor 330, an identification signal indicating identification information transmitted from the flying body and received by the third sensor 330. The identification signal reception unit 150 sends the information of the received identification signal and the sensor identification information for identifying the third sensor 330 that has received the identification signal to the identification information determination unit 160. In a case where the plurality of third sensors 330 receive the identification signal indicating the same identification information, the identification signal reception unit 150 transmits a combination of the information of one identification signal and the sensor identification information of the plurality of third sensors to the identification information determination unit 160. The information of the identification signal may include an identification signal indicated by the identification signal and information indicating strength of the identification signal.

### Identification Information Determination Unit 160

The identification information determination unit 160 receives, from the identification signal reception unit 150, the information of the identification signal and the sensor identification information for identifying third sensor 330 that has received the identification signal. As described above, the information of the identification signal includes the identification information indicated by the identification signal. The information of the identification signal may include information indicating strength of the identification signal.

The identification information determination unit 160 estimates, from the sensor identification information for identifying the third sensor 330 that has received the identification signal and the position of the third sensor 330, a possible existence range that is a range in which the flying body that has transmitted the identification signal is likely to be positioned. In this case, for example, the identification information determination unit 160 may set a range in which a distance from the third sensor 330 specified by the sensor identification information is within a distance that can be received by the third sensor 330 and that can be reached by the identification signal, as the possible existence range.

In a case where the identification signal has received only one third sensor 330, and the information on the identification signal includes information indicating the strength of the identification signal, the identification information determination unit 160 may determine the possible existence range as follows, for example.

The identification information determination unit 160 may set, as the possible existence range, a range in which the sensor identification information for identifying the third sensor 330 that has received the identification signal and the strength of the identification signal from the flying body can be equivalent to the strength of the identification signal included in the information of the identification signal at the position of the third sensor 330. Specifically, for example, the identification information determination unit 160 may calculate a distance at which the strength of the transmitted identification signal becomes the strength of the detected identification signal by attenuation. The identification information determination unit 160 may set, as the possible existence range, an annular region in which the distance from the position of the third sensor 330 includes a circle of the calculated distance and has a width determined by an appropriately determined method.

The identification information determination unit 160 may regard the prescribed area as a plane. The identification information determination unit 160 may assume that the flying body is flying at a prescribed height. In this case, the identification information determination unit 160 may calculate a distance at which an identification signal having the same strength as the strength of the identification signal included in the information of the identification signal is theoretically observed when the flying body is flying at a prescribed height. The identification information determination unit 160 may evaluate the calculated distance error using a method appropriately determined in advance. In other words, the identification information determination unit 160 may estimate the maximum value and the minimum value of the distance to the flying body in a case where the error is taken into consideration. The identification information determination unit 160 may set a circle obtained by projecting a circle whose height is a prescribed height and whose distance from the third sensor 330 is the minimum value of the estimated distance on a plane representing the prescribed area as the inner circumference of the possible existence amount range. The identification information determination unit 160 may set a circle obtained by projecting a circle whose height is a prescribed height and whose distance from the third sensor 330 is the maximum value of the estimated distance on a plane representing the prescribed area as the outer periphery of the possible existence amount range.

The identification information determination unit 160 may set the range of the height at which the flying body flies as a prescribed range. The minimum value of the prescribed range of the height is referred to as a minimum height, and the maximum value of the prescribed range of the height is referred to as a maximum height. In this case, the identification information determination unit 160 may calculate a circle in which the flying body may exist in a case where the altitude at which the flying body flies is the minimum height, and the distance from the third sensor 330 to the flying body is the distance at which the identification signal having the same strength as the strength of the identification signal included in the information of the identification signal is observed. The identification information determination unit 160 may set a circle obtained by projecting the calculated circle on a plane representing the prescribed area as the outer periphery of the possible existence amount range. The identification information determination unit 160 may calculate a circle in which the flying body may exist in a case where the altitude at which the flying body flies is the minimum height, and the distance from the third sensor 330 to the flying body is the distance at which the identification signal having the same strength as the strength of the identification signal included in the information of the identification signal is observed. The identification information determination unit 160 may set a circle obtained by projecting the calculated circle on a plane representing the prescribed area as the inner periphery of the possible existence amount range.

Also in this case, the identification information determination unit 160 may evaluate the distance error. In this case, as described above, the identification information determination unit 160 may estimate the maximum value and the minimum value of the distance to the flying body (that is, the distance at which the identification signal having the same strength as the strength of the identification signal included in the information of the identification signal is observed) in a case where the error is taken into consideration. In this case, the identification information determination unit 160 may calculate a circle in which the flying body may exist in a case where the height at which the flying body flies is the minimum height, and the distance from the third sensor 330 to the flying body is the maximum value of the distance to the flying body in a case where the error is taken into consideration. The identification information determination unit 160 may set a circle obtained by projecting the calculated circle on a plane representing the prescribed area as the outer periphery of the possible existence amount range. The identification information determination unit 160 may calculate a circle in which the flying body may exist in a case where the height at which the flying body flies is the maximum height and the distance from the third sensor 330 to the flying body is the minimum value of the distance in consideration of the error. The identification information determination unit 160 may set a circle obtained by projecting the calculated circle on a plane representing the prescribed area as the inner periphery of the possible existence amount range.

The method of calculating the possible existence range is not limited to the above example.

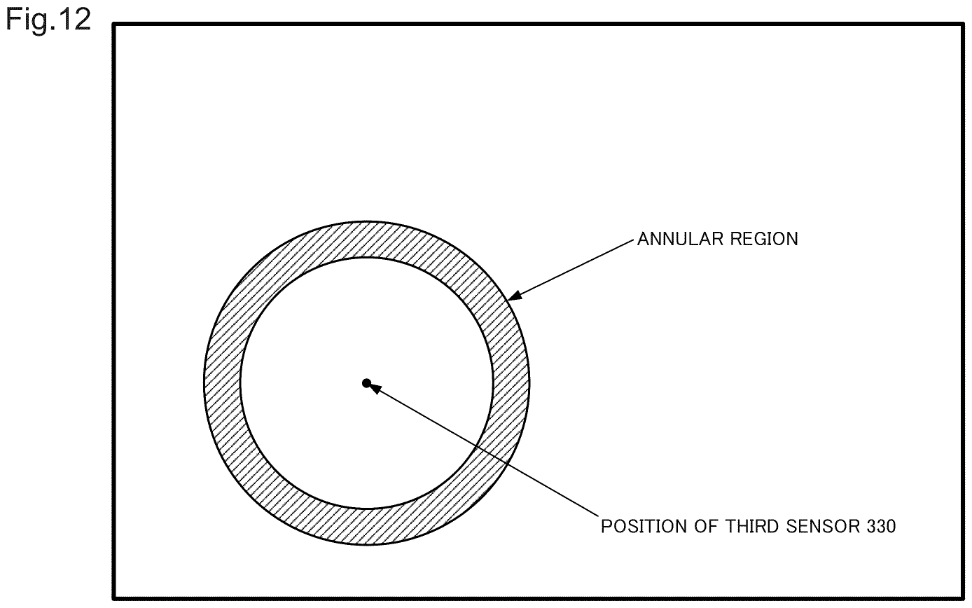

FIG. 12 is a diagram schematically illustrating an annular possible existence range of the flying body. In the example illustrated in FIG. 12, the inside of the rectangular shape is the above-described prescribed area. A hatched area is the possible existence range.

In a case where the plurality of third sensors 330 receive the identification signal, the identification information determination unit 160 may calculate the possible existence range using the strength of the identification signals received by the plurality of third sensors. In this case, for example, the identification information determination unit 160 may calculate the above-described annular region for each of the plurality of third sensors 330, and set a common portion of the plurality of calculated annular regions as the possible existence range.

The identification information determination unit 160 may estimate the possible existence range by another method.

The identification information determination unit 160 transmits, to the permission determination unit 170, the identification information of the flying body and the possible existence range of the flying body to which the identification information is assigned.

### Permission Determination Unit 170

The permission determination unit 170 receives, from the specific information determination unit 140, information on the position of the flying body determined to have emitted a signal having the prescribed pattern and information on the position of the flying body determined not to have emitted a signal having the prescribed pattern.

The permission determination unit 170 receives, from the identification information determination unit 160, the identification information of the flying body and the possible existence range of the flying body to which the identification information is assigned.

The permission determination unit 170 may receive, from the position determination unit 120, the estimated position of the flying body determined to be in the prescribed area.

The permission determination unit 170 determines whether the received identification information of the flying body is included in the list of identification information of the flying body to which the mission in the prescribed area is assigned. The list of identification information of the flying body to which the mission in the prescribed area is assigned (hereinafter, referred to as a permission list) may be given to the permission determination unit 170 in advance.

The permission determination unit 170 associates the identification information indicated by the identification signal transmitted from the flying body included in the possible existence range with the flying body included in the possible existence range received from the identification information determination unit 160 among the flying bodies whose positions have received from the specific information determination unit 140. The permission determination unit 170 may associate the plurality of pieces of identification information with the flying bodies of the plurality of pieces of identification information included in the possible existence range.

In a case where a signal having the prescribed pattern is emitted from the flying body determined to be in the prescribed area, the permission determination unit 170 determines that the flying body is an authorized flying body. In a case where a signal having the prescribed pattern is not emitted from the flying body determined to be in the prescribed area and identification information that is not included in the permission list is associated with the flying body, the permission determination unit 170 determines that the flying body is an unauthorized flying body. In a case where the signal having the prescribed pattern is not emitted from the flying body determined to be in the prescribed area and only the identification information included in the permission list is associated with the flying body, the permission determination unit 170 determines that the flying body is an authorized flying body. In a case where the signal having the prescribed pattern is not emitted from the flying body determined to be in the prescribed area and the identification information is not associated with the flying body, the permission determination unit 170 determines that the flying body is an unauthorized flying body.

In a case where there is a flying body determined to be an unauthorized flying body, the permission determination unit 170 transmits, to the generation unit 180, information on the position of the flying body determined to be an unauthorized flying body. In a case where there is a flying body determined to be an authorized flying body, the permission determination unit 170 transmits, to the generation unit 180, information on the position of the flying body determined to be an authorized flying body.

### Generation Unit 180

In a case where there is a flying body determined to be an unauthorized flying body, the generation unit 180 receives, from the permission determination unit 170, information on the position of the flying body determined to be an unauthorized flying body. In a case where there is a flying body determined to be an authorized flying body, the generation unit 180 receives, from the permission determination unit 170, information on the position of the flying body determined to be an authorized flying body.

In a case of receiving the information on the position of the flying body determined to be an unauthorized flying body, the generation unit 180 superimposes a mark indicating an unauthorized flying body on a position relevant to the position of the flying body determined to be an unauthorized flying body in the image representing the prescribed area. In a case of receiving the information on the position of the flying body determined to be an authorized flying body, the generation unit 180 superimposes a mark indicating an authorized flying body on the position relevant to the position of the flying body determined to be an authorized flying body in the image representing the prescribed area. The mark indicating an unauthorized flying body and the mark indicating an authorized flying body may be a figure, a letter, a combination of a figure and a letter, or the like that are appropriately determined in advance. The mark indicating an unauthorized flying body is different from the mark indicating an authorized flying body. The generation unit 180 generates the notification image by superimposing the mark on the image representing the prescribed area. In other words, the notification image is an image representing a prescribed area on which the above-described mark is superimposed.

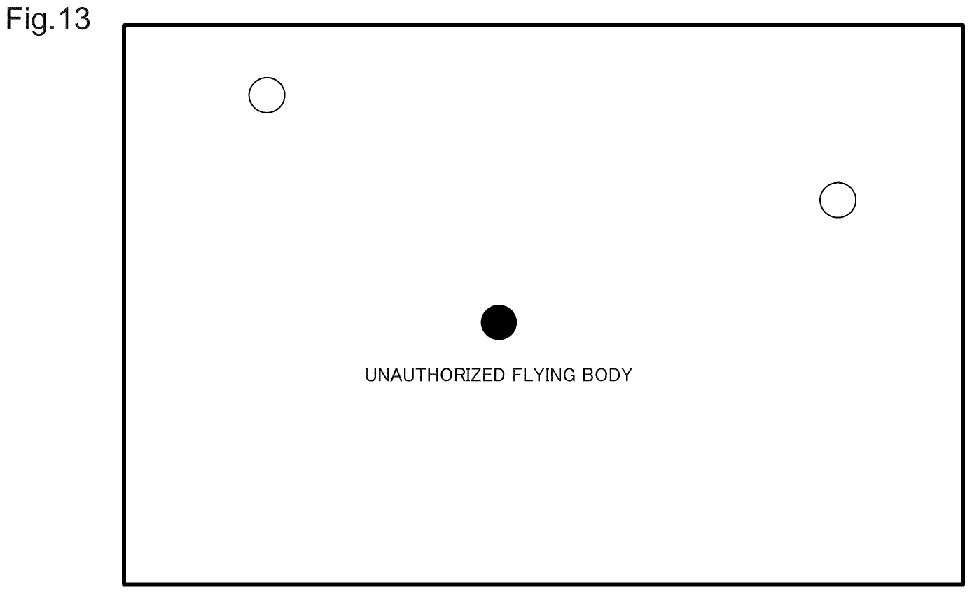

FIG. 13 is a diagram illustrating an example of a notification image in which the marks are superimposed. In the example illustrated in FIG. 13, the mark representing the authorized flying body is a circle to which no letter is added (that is, a white circle). In the example illustrated in FIG. 13, the mark representing the unauthorized flying body is a circle (that is, a black circle) to which a letter string “unauthorized flying body” is added.

The image representing the prescribed area may be, for example, a map of a region including the prescribed area. In this case, the position relevant to the position of the flying body may be a position where the position of the flying body is projected onto the ground. The generation unit 180 calculates a position at which the position of the flying body is projected onto the ground. Then, in a case where the flying body is an unauthorized flying body, the generation unit 180 superimposes the mark indicating an unauthorized flying body on the calculated position of the flying body on the map including the prescribed area. In a case where the flying body is an authorized flying body, the generation unit 180 superimposes the mark indicating an authorized flying body on the calculated position of the flying body on the map including the prescribed area. The generation unit 180 may store a map of the area including the prescribed area in advance.

The image representing the prescribed area may be, for example, an image obtained by capturing a part or the whole of the prescribed area. In this case, the image representing the prescribed area may be an image captured by any of the first sensors 310. Then, the position relevant to the position of the flying body may be, for example, a region of the flying body detected by the position determination unit 120 in the image captured by any of the first sensors 310. The generation unit 180 superimposes the mark indicating an unauthorized flying body on the captured image so as to indicate a region where the unauthorized flying body is detected in the captured image. The generation unit 180 superimposes the mark indicating an authorized flying body on the captured image so as to indicate a region where the authorized flying body is detected in the captured image. In this case, the position determination unit 120 transmits, to the generation unit 180, the image in which the flying body is detected. The generation unit 180 receives, from the position determination unit 120, the image in which the flying body is detected.

The generation unit 180 transmits the generated notification image to the notification unit 190.

### Notification Unit 190

The notification unit 190 receives the notification image from the generation unit 180. The notification unit 190 notifies the notification destination device 200 of the received notification image.

### Notification Destination Device 200

The notification destination device 200 receives the notification image from the notification unit 190 and displays the received notification image. The notification destination device 200 is relevant to a prescribed notification destination in the first example embodiment.

### Operation

Next, an operation of the information provision device 100 according to the second example embodiment of the present disclosure will be described in detail with reference to the drawings.

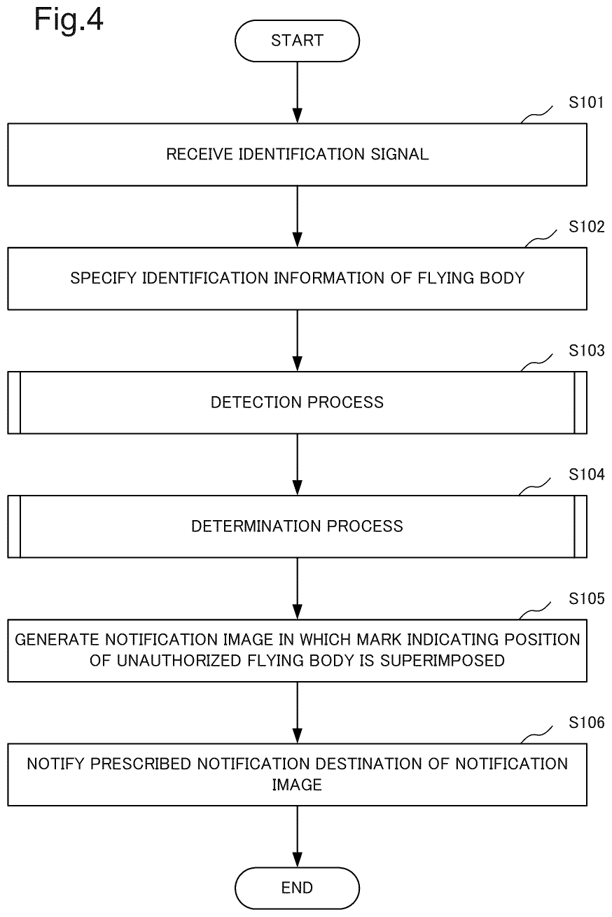

FIG. 4 is a flowchart illustrating an example of the entire operation of the information provision device 100 according to the second example embodiment of the present disclosure.

In the example illustrated in FIG. 4, first, the identification signal reception unit 150 receives the identification signal (step S101). Next, the identification information determination unit 160 specifies identification information of the flying body (step S102). In step S102, the identification information determination unit 160 may calculate a range in the presence of the flying body.

Next, the information provision device 100 executes a detection process (step S103). By the detection process in step S103, the position of the flying body is detected from the measurement data by the first sensor 310. Then, the information provision device 100 executes a determination process (step S104). By the determination process of step S104, whether the detected flying body is an unauthorized flying body or an authorized flying body is determined. The detection process and the determination process will be described in detail later.

Next, the generation unit 180 generates a notification image in which a mark indicating the position of an unauthorized flying body is superimposed (step S105). The generation unit 180 may superimpose a mark indicating the position of an authorized flying body on the notification image.

Then, the notification unit 190 notifies a prescribed notification destination (specifically, the notification destination device 200) of the notification image (step S106).

Next, detection process and determination process will be described.

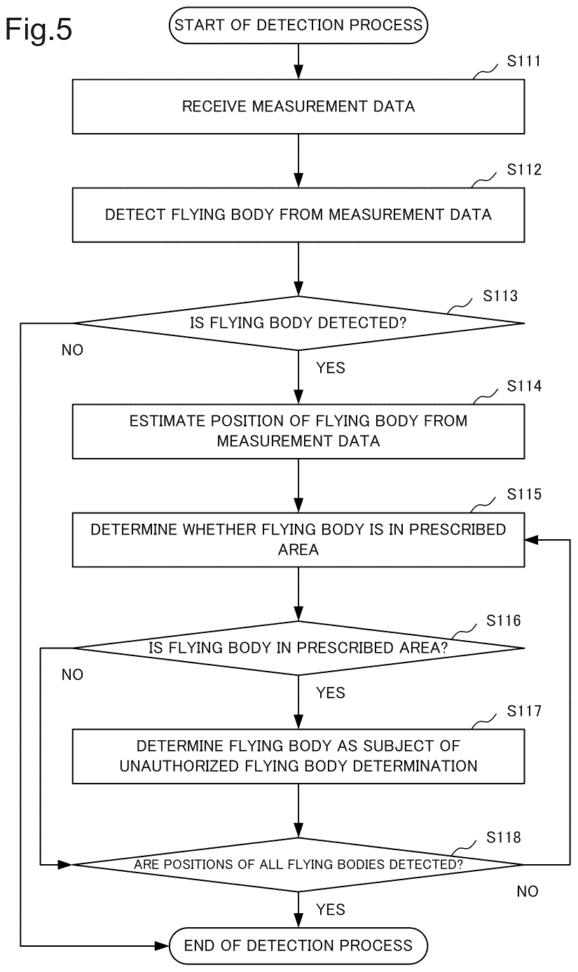

FIG. 5 is a flowchart illustrating an example of an operation of the detection process of the information provision device 100 according to the second example embodiment of the present disclosure.

In the example illustrated in FIG. 5, the measurement data reception unit 110 receives the measurement data (step S111). Specifically, the measurement data is, for example, an image captured by the first sensor 310 which is an imaging device. Next, the position determination unit 120 detects a flying body from the measurement data (step S112). In a case where any flying body is not detected (NO in step S113), the information provision device 100 ends the operation illustrated in FIG. 5.

In a case where a flying body is detected (YES in step S113), the position determination unit 120 estimates the position of the flying body from the measurement data. Specifically, the position determination unit 120 estimates the position of the flying body appearing in the plurality of images from the plurality of images captured by the plurality of first sensors 310. The position determination unit 120 determines whether the estimated position of the flying body is included in the prescribed area. In other words, the position determination unit 120 determines whether the detected flying body is in the prescribed area (step S115). In a case where a plurality of flying bodies is detected, the position determination unit 120 selects one flying body from the detected flying bodies and performs the operation of step S115 on the selected flying body. In a case where the flying body is not in the prescribed area (NO in step S115), the operation of the information provision device 100 proceeds to step S118.

In a case where the flying body is in the prescribed area (YES in step S116), the position determination unit 120 determines the flying body as a subject of the unauthorized flying body determination (step S117). In a case where there is a flying body whose position has not been determined in the detected flying bodies, specifically, in a case where there is a flying body whose position has not been determined to be in the prescribed area in the detected flying bodies (YES in step S118), the operation of the information provision device 100 returns to step S115.

In a case where the positions of all the detected flying bodies have been determined, specifically, in a case where it has been determined whether the positions of all the detected flying bodies are in the prescribed area (YES in step S118), the information provision device 100 ends the operation illustrated in FIG. 5.

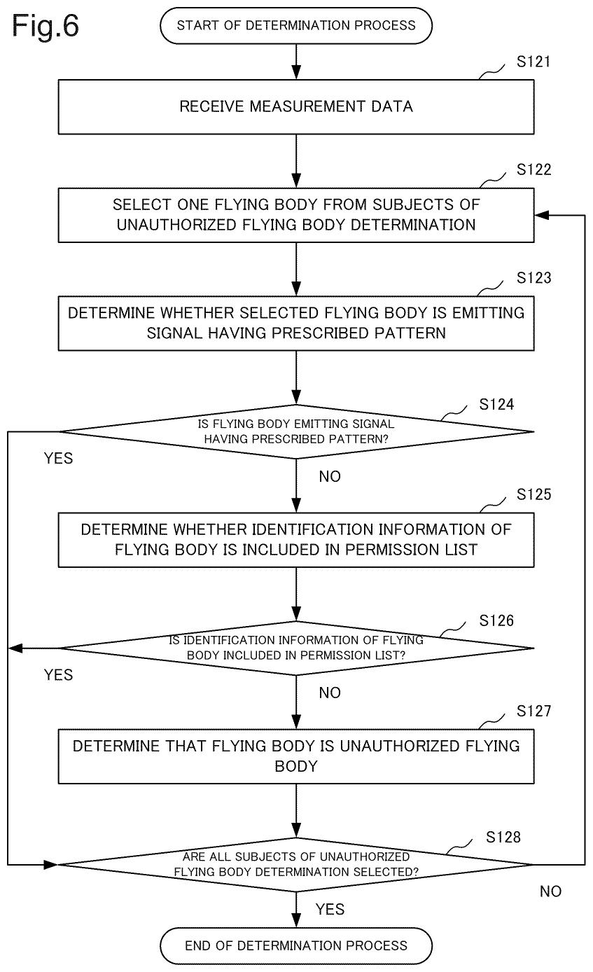

FIG. 6 is a flowchart illustrating an operation of the determination process of the information provision device 100 according to the second example embodiment of the present disclosure.

In the example illustrated in FIG. 6, first, the specific signal reception unit 130 receives the measurement data of the flying body (step S121). Specifically, the specific signal reception unit 130 receives, from the second sensor 320 as measurement data of the flying body, a moving image that the second sensor 320 as the imaging device images the flying body determined to be the subject of the unauthorized flying body determination.

Next, the specific information determination unit 140 selects one flying body from the subjects of the unauthorized flying body determination (step S122). Then, the specific information determination unit 140 determines whether the selected flying body is emitting a signal having the prescribed pattern (step S123). Specifically, the specific information determination unit 140 detects a signal having the prescribed pattern (for example, a region blinking in a prescribed pattern) in a region of the flying body of the moving image in which the selected flying body is imaged, which is received as the measurement data. In a case where a signal having the prescribed pattern (that is, the specific signal) is detected in the region of the flying body of the moving image in which the selected flying body is imaged, the specific information determination unit 140 determines that the selected flying body is emitting a signal having the prescribed pattern. In a case where a signal having the prescribed pattern (that is, the specific signal) is not detected in the region of the flying body of the moving image in which the selected flying body is imaged, the specific information determination unit 140 determines that the selected flying body is not emitting a signal having the prescribed pattern. In a case where the flying body is emitting a signal having the prescribed pattern (YES in step S124), the operation of the information provision device 100 proceeds to step S128.

In a case where the flying body does not emit a signal having the prescribed pattern (NO in step S124), the permission determination unit 170 determines whether the identification information of the flying body is included in the permission list (step S125). In step S125, the permission determination unit 170 specifies the identification information of the possible existence range including the position of the flying body that is determined not emitting a signal having the prescribed pattern. The permission determination unit 170 determines whether the specified identification information is included in a permission list (that is, a list of identification information of the flying body permitted to enter the prescribed area) of the identification information. In a case where the position of the flying body is included in the possible existence range of the plurality of pieces of identification information, the permission determination unit 170 specifies the plurality of pieces of identification information. Here, in a case where all the specified identification information is included in the permission list, the permission determination unit 170 may determine that the identification information of the flying body is included in the permission list. In a case where at least one of the specified identification information is not included in the permission list, the permission determination unit 170 may determine that the identification information of the flying body is not included in the permission list. In a case where there is no identification information in which the position of the flying body is included in the possible existence range, the permission determination unit 170 determines that the identification information of the flying body is not included in the permission list.

In a case where the identification information of the flying body is included in the permission list (YES in step S126), the operation of the information provision device 100 proceeds to step S128. Note that the permission determination unit 170 may determine a flying body that has not been determined to be an unauthorized flying body as an authorized flying body. In a case where the identification information of the flying body is not included in the permission list, the permission determination unit 170 determines that the flying body is an unauthorized flying body (step S127). In a case where there is a subject of the unauthorized flying body determination which is not yet selected (NO in step S128), the operation of the information provision device 100 returns to step S122.

In a case where all the subjects of the unauthorized flying body have been selected (YES in step S128), the information provision device 100 ends the operation illustrated in FIG. 6.

### Effects

The present example embodiment has the same effects as those of the first example embodiment. The reason is the same as the reason why the effects of the first example embodiment are achieved.

### Example of Signal of Prescribed Pattern

In the example of the second example embodiment, the signal having the prescribed pattern (that is, the specific signal) is a blinking pattern of light emitted by one light emitting element, but the prescribed pattern is not limited to this example. The signal having the prescribed pattern may be a blinking pattern of the plurality of light emitting elements. In this case, the blinking pattern of the plurality of light emitting elements may be different for each light emitting element. The signal having the prescribed pattern may be a light emission pattern of a plurality of light emitting elements arranged on a straight, curved, or planar arrangement. The light emission pattern in this case may be a pattern of an array of light emitting elements that emit light. The light emission pattern in this case may be a color pattern emitted by the light emitting element. The light emission pattern in this case may be a pattern of intensity of light emitted from the light emitting element. The light emission pattern in this case may be a pattern of a combination of at least one of the array of the light emitting elements that emit light, the color of the light emitted by the light emitting elements, and the intensity of light emitted by the light emitting elements. The light emitting element may continuously emit light with the same brightness without blinking. The light emission pattern may be a pattern of a change in at least one of the array of light emitting elements that emit light, the color of the light emitted by the light emitting elements, and the intensity of the light emitted by the light emitting elements.

The signal having the prescribed pattern may have, for example, a shape of a reflection portion that reflects light of a prescribed wavelength. In this case, the reflection portion in the prescribed shape that reflects light of the prescribed wavelength may be attached to the authorized flying body. The reflection portion in the prescribed shape may be a portion of a figure in a prescribed shape drawn on a seal, a plate, or the like with a coating material or the like that reflects light of the prescribed wavelength. A certificate for irradiating a flying body flying in the prescribed area with light of the prescribed wavelength may be installed. A search light that emits light of the prescribed wavelength may be installed to irradiate a flying body detected by the position determination unit 120. Such a search light may be controlled by, for example, a device that receives the position of a detected flying body from the position determination unit 120 of the information provision device 100 and controls the irradiation direction of the search light so that the region including the received position of the flying body is irradiated with the light of the search light.

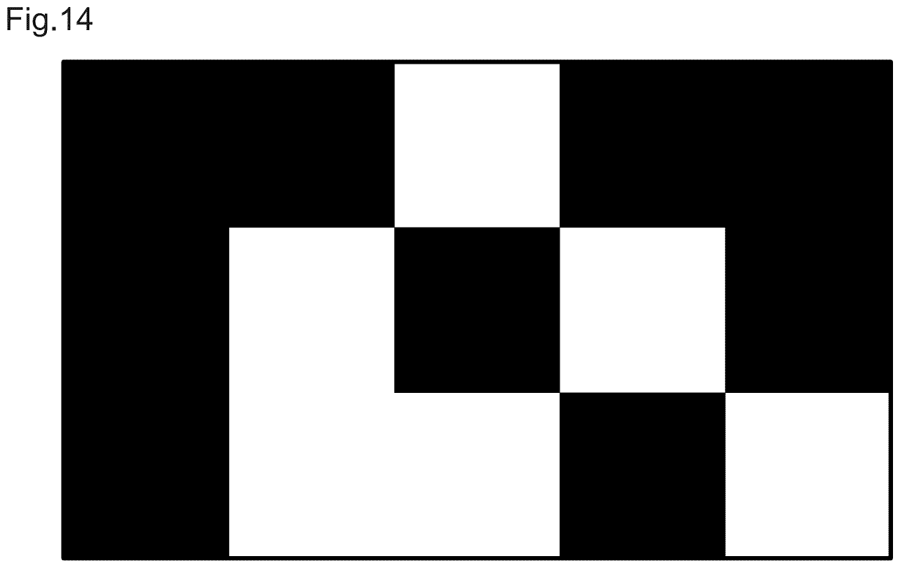

FIG. 14 is a diagram illustrating an example of the shape of the reflection portion. In the example illustrated in FIG. 14, the rectangle on the outer periphery represents a member such as a seal or a plate on which the reflection portion is drawn. The black portions represent the reflection portion that reflects light of the prescribed wavelength. The figure illustrated in FIG. 14 is merely an example. The shape of the reflection portion is not limited to the figure illustrated in FIG. 14.

### Another Example of Information to be Notified

The information notified by the notification unit 190 is not limited to the notification image. The notification unit 190 may notify information indicating the position of the unauthorized flying body. The notification unit 190 may notify the identification information of the unauthorized flying body.

An imaging device may be connected to the notification destination device 200. The notification destination device 200 may receive the information indicating the position of the unauthorized flying body and superimpose a mark indicating an unauthorized flying body on a place where the position of the unauthorized flying body appears in the image captured by the imaging device connected to the notification destination device 200. The notification destination device 200 may display an image captured by the imaging device connected to the notification destination device 200 with a superimposed mark indicating an unauthorized flying body. The notification destination device 200 may further receive information indicating the position of an authorized flying body, and superimpose a mark indicating the authorized flying body on a place where the position of the authorized flying body appears in the image captured by the imaging device connected to the notification destination device 200. The notification destination device 200 may display an image captured by the imaging device connected to the notification destination device 200, in which a mark indicating an unauthorized flying body is superimposed on a place where the position of the unauthorized flying body appears, and a mark indicating an authorized flying body is superimposed on a place where the position of the authorized flying body appears.

### Example of Notification Destination

The notification destination (for example, the administrator of the notification destination device 200) of the information about the unauthorized flying body may be, for example, an administrator who manages work in the prescribed area. The notification destination of the information on the unauthorized flying body may be, for example, an operator of the authorized flying body in the prescribed area. The notification destination of the information of the unauthorized flying body may be the police, the fire department, an administrator of helicopters taking in and out around the prescribed area, an administrator of helicopters flying around the prescribed area, or the like.

### Third Example Embodiment

Next, a flying body according to a third example embodiment of the present disclosure will be described in detail with reference to the drawings.

### Configuration

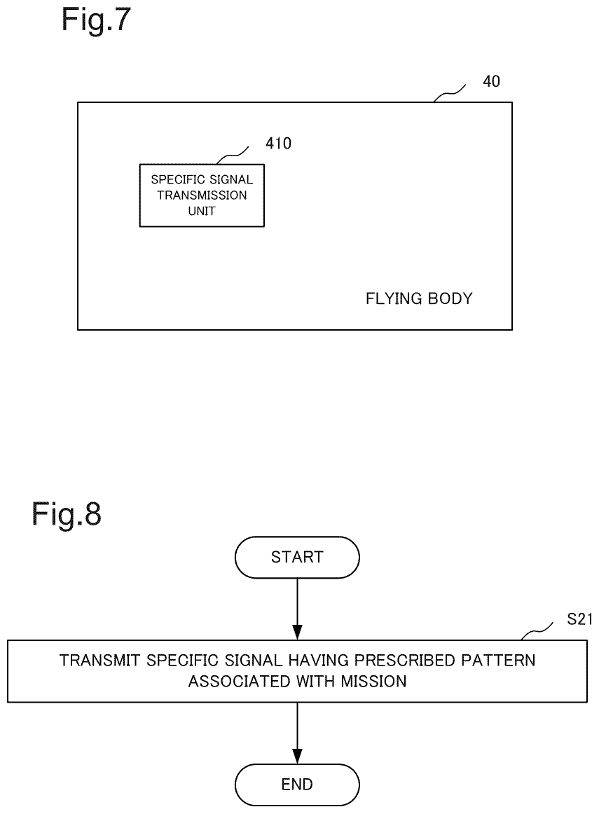

FIG. 7 is a block diagram illustrating an example of a configuration of a flying body according to the third example embodiment of the present disclosure. In the example illustrated in FIG. 7, a flying body 40 according to the present example embodiment includes a specific signal transmission unit 410. The specific signal transmission unit 410 emits a specific signal having a prescribed pattern assigned to a mission in a prescribed area. The specific signal of the present example embodiment is the same as the specific signal of the second example embodiment. The specific signal transmission unit 410 is the same as a portion that transmits the specific signal of the second example embodiment.

### Operation

FIG. 8 is a flowchart illustrating an example of the operation of the flying body according to the third example embodiment of the present disclosure. In the example illustrated in FIG. 8, the specific signal transmission unit 410 transmits a specific signal having a prescribed pattern associated with the mission (step S21).

### Modification of Third Example Embodiment

Next, a flying body according to a modification of the third example embodiment of the present disclosure will be described to the president with reference to the drawings.

### Configuration

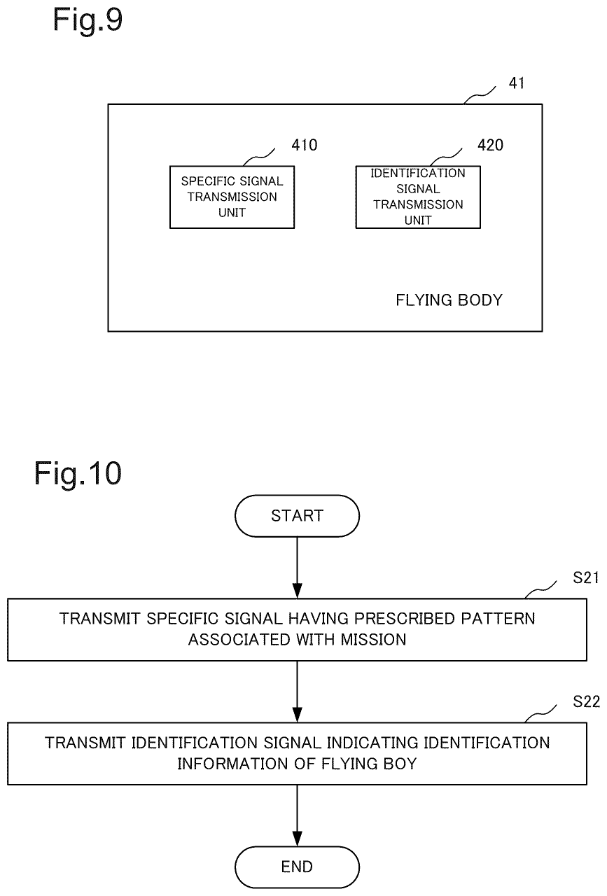

FIG. 9 is a block diagram illustrating an example of a configuration of a flying body according to a modification of the third example embodiment of the present disclosure. In the example illustrated in FIG. 9, a flying body 41 according to the present modification includes a specific signal transmission unit 410 and an identification signal transmission unit 420. The specific signal transmission unit 410 of the present modification is the same as the specific signal transmission unit 410 of the third example embodiment. The identification signal transmission unit 420 emits an identification signal indicating identification information of the flying body (also referred to as flying body identification information). The identification signal is a signal different from the above-described specific new term.

### Operation

FIG. 10 is a flowchart illustrating an example of the operation of the flying body 41 according to the modification of the third example embodiment of the present disclosure. In the example illustrated in FIG. 10, the specific signal transmission unit 410 transmits a specific signal having a prescribed pattern associated with the mission (step S21). Further, the identification signal transmission unit 420 transmits an identification signal indicating identification information of the flying body (step S22).

### Other Example Embodiments

The information provision device 10 and the information provision device 100 can be achieved by a computer including a memory in which a program read from a storage medium is loaded and a processor that executes the program. The information provision device 10 and the information provision device 100 can also be achieved by dedicated hardware. The information provision device 10 and the information provision device 100 can also be achieved by a combination of the above-described computer and dedicated hardware.

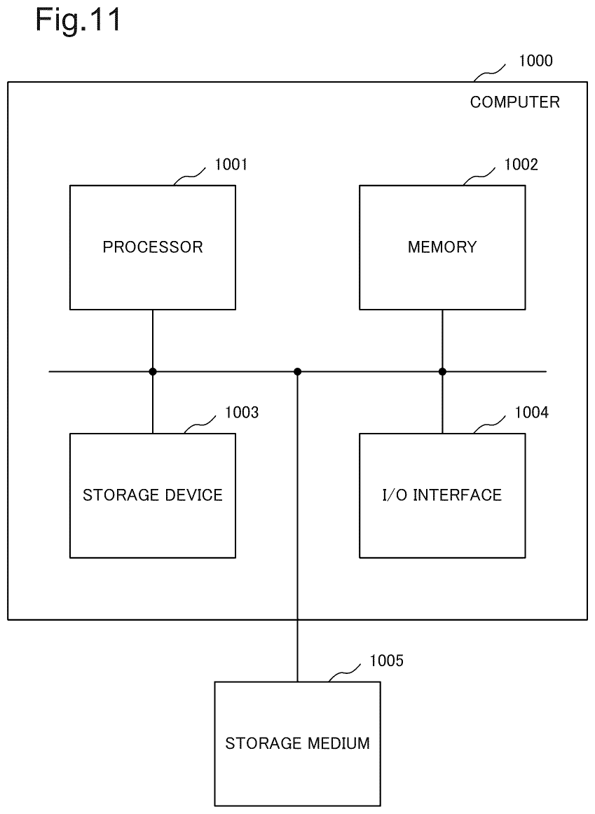

FIG. 11 is a diagram illustrating an example of a hardware configuration of a computer 1000 that can implement the information provision device according to the example embodiments of the present disclosure. In the example illustrated in FIG. 11, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data or programs from and in the memory 1002 and the storage device 1003. The processor 1001 can access, for example, the sensor and the notification destination device 200 via the I/O interface 1004. The processor 1001 may access the storage medium 1005. The storage medium 1005 stores a program for operating the computer 1000 as the information provision devices according to the example embodiments of the present disclosure.

The processor 1001 loads a program, which is stored in the storage medium 1005 and causes the computer 1000 to operate as the information provision devices according to the example embodiments of the present disclosure, into the memory 1002. Then, the processor 1001 executes the program loaded in the memory 1002, whereby the computer 1000 operates as the information provision devices according to the example embodiments of the present disclosure.

The measurement data reception unit 110, the position determination unit 120, the specific signal reception unit 130, the specific information determination unit 140, the identification signal reception unit 150, the identification information determination unit 160, the permission determination unit 170, the generation unit 180, and the notification unit 190 can be achieved by, for example, the processor 1001 that executes a program loaded in the memory 1002. Some or all of the measurement data reception unit 110, the position determination unit 120, the specific signal reception unit 130, the specific information determination unit 140, the identification signal reception unit 150, the identification information determination unit 160, the permission determination unit 170, the generation unit 180, and the notification unit 190 can be achieved by a dedicated circuit that enables the function of each unit.

Further, some or all of the above example embodiments can also be described as the following supplementary notes, but are not limited to the following.

### (Supplementary Note 1)

An information provision device including:
a position determination means for determining whether a flying body is in a prescribed area based on measurement data of the flying body measured by a sensor;
a specific information determination means for determining whether a signal having a prescribed pattern associated with a mission in the prescribed area is received from the flying body that has been determined to be in the prescribed area;
a permission determination means for determining, if no signal having the prescribed pattern is received from the flying body, that the flying body is an unauthorized flying body that is not permitted to enter the prescribed area; and
a notification means for notifying a prescribed notification destination of information including the position of the unauthorized flying body.

### (Supplementary Note 2)

The information provision device according to Supplementary Note 1, in which
the flying body to which the mission is given is configured to transmit a signal having the prescribed pattern associated with the mission,
in a case where the signal having the prescribed pattern is received from the flying body, the permission determination means determines that the flying body is an authorized flying body permitted to enter the prescribed area, and
the notification means further notifies the prescribed notification destination of information about the flying body determined to be an authorized flying body.

### (Supplementary Note 3)

The information provision device according to Supplementary Note 2, in which
the prescribed pattern is associated in advance with each mission of the flying body in the prescribed area, and
the notification means notifies the prescribed notification destination of information about the flying body including information about the mission associated with the prescribed pattern of the signal transmitted by the flying body that is determined to be an authorized flying body.

### (Supplementary Note 4)

The information provision device according to any one of Supplementary Notes 1 to 3, further including
an identification signal reception means for receiving an identification signal indicating flying body identification information that is an identifier of the flying body, the identification signal being transmitted from the flying body, in which
the notification means notifies the prescribed notification destination of the flying body identification information indicated by the detected identification signal together with coincidence information of the flying body indicated by the flying body identification information.

### (Supplementary Note 5)

The information provision device according to Supplementary Note 4, in which
in a case where the flying body identification information indicated by the detected identification signal is not included in a working flying body list that is a list of flying body identification information of the flying body to which the mission in the prescribed area is assigned, the permission determination means determines the flying body indicated by the flying body identification information as an unauthorized flying body.

### (Supplementary Note 6)

The information provision device according to any one of Supplementary Notes 1 to 5, further including
a generation means for generating, as information about the unauthorized flying body, a display image in which a mark indicating the position of the unauthorized flying body is superimposed on the image of the prescribed area.

### (Supplementary Note 7)

The information provision device according to Supplementary Note 6, in which
the generation means generates the display image in which another mark is superimposed, the another mark being different from the mark of the unauthorized flying body and indicating the position of the flying body that is not the unauthorized flying body.

### (Supplementary Note 8)

The information provision device according to Supplementary Notes 6 or 7, in which
the image of the prescribed area is a map of an area including the prescribed area or an image obtained by photographing the prescribed area.

### (Supplementary Note 9)

The information provision device according to any one of Supplementary Note 1 to 8, in which
the flying body includes a reflection portion in a prescribed shape that reflects light when being irradiated with light of a prescribed wavelength, and
the specific information determination means detects the reflected light in the prescribed shape as the signal having the prescribed pattern from the image of the flying body irradiated with the light of the prescribed wavelength.

### (Supplementary Note 10)

A flying body including
a specific signal transmission means for emitting a specific signal having a prescribed pattern, the specific signal being associated with a mission in a prescribed area.

### (Supplementary Note 11)

The flying body according to Supplementary Note 10, in which the specific signal transmission means is a reflection portion in a prescribed shape that reflects light when being irradiated with light of a prescribed wavelength.

### (Supplementary Note 12)

The flying body according to Supplementary Note 10 or 11, further including
an identification signal transmission means for emitting an identification signal indicating flying body identification information, the identification signal being different from the specific signal.

### (Supplementary Note 13)

An information provision method including:
determining whether a flying body is in a prescribed area based on measurement data of the flying body measured by a sensor;
determining whether a signal having a prescribed pattern associated with a mission in the prescribed area is received from the flying body that has been determined to be in the prescribed area;
determining, if no signal having the prescribed pattern is received from the flying body, that the flying body is an unauthorized flying body that is not permitted to enter the prescribed area; and
notifying a prescribed notification destination of information including a position of the unauthorized flying body.

### (Supplementary Note 14)

The information provision method according to Supplementary Note 13, in which
the flying body to which the mission is given is configured to transmit a signal having the prescribed pattern associated with the mission,
the method further including:
determining, in a case where the signal having the prescribed pattern is received from the flying body, that the flying body is an authorized flying body permitted to enter the prescribed area, and
notifying the prescribed notification destination of information about the flying body determined to be an authorized flying body.

### (Supplementary Note 15)

The information provision method according to Supplementary Note 14, in which
the prescribed pattern is associated in advance with each mission of the flying body in the prescribed area,
the method further including:
notifying the prescribed notification destination of information about the flying body including information about the mission associated with the prescribed pattern of the signal transmitted by the flying body that is determined to be an authorized flying body.

### (Supplementary Note 16)

The information provision method according to any one of Supplementary Note 13 to 15, further including:
receiving an identification signal indicating flying body identification information that is an identifier of the flying body, the identification signal being transmitted from the flying body; and
notifying the prescribed notification destination of the flying body identification information indicated by the detected identification signal together with coincidence information of the flying body indicated by the flying body identification information.

### (Supplementary Note 17)

The information provision method according to Supplementary Note 16, further including
determining the flying body indicated by the flying body identification information as an unauthorized flying body in a case where the flying body identification information indicated by the detected identification signal is not included in a working flying body list that is a list of flying body identification information of the flying body to which the mission in the prescribed area is assigned.

### (Supplementary Note 18)

The information provision method according to any one of Supplementary Notes 13 to 17, further including
generating, as information about the unauthorized flying body, a display image in which a mark indicating the position of the unauthorized flying body is superimposed on the image of the prescribed area.

### (Supplementary Note 19)

The information provision method according to Supplementary Note 18, further including
generating the display image in which another mark is superimposed, the another mark being different from the mark of the unauthorized flying body and indicating the position of the flying body that is not the unauthorized flying body.

### (Supplementary Note 20)

The information provision method according to Supplementary Note 18 or 19, in which
the image of the prescribed area is a map of an area including the prescribed area or an image obtained by photographing the prescribed area.

### (Supplementary Note 21)

The information provision method according to any one of Supplementary Notes 13 to 20, in which
the flying body includes a reflection portion in a prescribed shape that reflects light when being irradiated with light of a prescribed wavelength,
the method further including
detecting the reflected light in the prescribed shape as the signal having the prescribed pattern from the image of the flying body irradiated with the light of the prescribed wavelength.

### (Supplementary Note 22)

A storage medium storing a program for causing a computer to execute a process, the process including:
a position determination process for determining whether a flying body is in a prescribed area based on measurement data of the flying body measured by a sensor;
a specific information determination process for determining whether a signal having a prescribed pattern associated with a mission in the prescribed area is received from the flying body that has been determined to be in the prescribed area;
a permission determination process for determining, if no signal having the prescribed pattern is received from the flying body, that the flying body is an unauthorized flying body that is not permitted to enter the prescribed area; and
a notification process for notifying a prescribed notification destination of information including the position of the unauthorized flying body.

### (Supplementary Note 23)

The storage medium according to Supplementary Note 22, in which
the flying body to which the mission is given is configured to transmit a signal having the prescribed pattern associated with the mission,
in a case where the signal having the prescribed pattern is received from the flying body, the permission determination process determines that the flying body is an authorized flying body permitted to enter the prescribed area, and
the notification process further notifies the prescribed notification destination of information about the flying body determined to be an authorized flying body.

### (Supplementary Note 24)

The storage medium according to Supplementary Note 23, in which
the prescribed pattern is associated in advance with each mission of the flying body in the prescribed area, and
the notification process notifies the prescribed notification destination of information about the flying body including information about the mission associated with the prescribed pattern of the signal transmitted by the flying body that is determined to be an authorized flying body.

### (Supplementary Note 25)

The storage medium according to any one of Supplementary Notes 22 to 24, the program further causing the computer to execute the process including
an identification signal reception process for receiving an identification signal indicating flying body identification information that is an identifier of the flying body, the identification signal being transmitted from the flying body, in which
the notification process notifies the prescribed notification destination of the flying body identification information indicated by the detected identification signal together with coincidence information of the flying body indicated by the flying body identification information.

### (Supplementary Note 26)

The storage medium according to Supplementary Note 25, in which
in a case where the flying body identification information indicated by the detected identification signal is not included in a working flying body list that is a list of flying body identification information of the flying body to which the mission in the prescribed area is assigned, the permission determination process determines the flying body indicated by the flying body identification information as an unauthorized flying body.

### (Supplementary Note 27)

The storage medium according to any one of Supplementary Notes 22 to 26, the program further causing the computer to execute the process including
a generation process for generating, as information about the unauthorized flying body, a display image in which a mark indicating the position of the unauthorized flying body is superimposed on the image of the prescribed area.

### (Supplementary Note 28)

The storage medium according to Supplementary Note 27, in which
the generation process generates the display image in which another mark is superimposed, the another mark being different from the mark of the unauthorized flying body and indicating the position of the flying body that is not the unauthorized flying body.

### (Supplementary Note 29)

The storage medium according to Supplementary Note 27 or 28, in which
the image of the prescribed area is a map of an area including the prescribed area or an image obtained by photographing the prescribed area.

### (Supplementary Note 30)

The storage medium according to any one of Supplementary Notes 22 to 29, in which
the flying body includes a reflection portion in a prescribed shape that reflects light when being irradiated with light of a prescribed wavelength, and
the specific information determination process detects the reflected light in the prescribed shape as the signal having the prescribed pattern from the image of the flying body irradiated with the light of the prescribed wavelength.

While the present disclosure has been particularly shown and described with reference to exemplary embodiments thereof, the present disclosure is not limited to these embodiments. It will be understood by those of ordinary skill in the art that various changes in form and details may be made therein without departing from the spirit and scope of the present disclosure as defined by the claims.

### REFERENCE SIGNS LIST

10 information provision device
40 flying body
41 flying body
100 information provision device
110 measurement data reception unit
120 position determination unit
130 specific signal reception unit
140 specific information determination unit
150 identification signal reception unit
160 identification information determination unit
170 permission determination unit
180 generation unit
190 notification unit
200 notification destination device
300 sensor unit
310 first sensor
320 second sensor
330 third sensor
410 specific signal transmission unit
420 identification signal transmission unit
1000 computer
1001 processor
1002 memory
1003 storage device
1004 I/O interface
1005 storage medium

What is claimed is:

1. An information provision device comprising:
at least one memory storing a set of instructions; and
at least one processor configured to execute the set of instructions to:
determine whether a flying body is in a predetermined area based on measurement data of the flying body measured by a sensor;
determine whether a signal is received from the flying body that has been determined to be in the predetermined area, the signal having a predetermined pattern associated with a mission in the predetermined area;
determine, if no signal having the predetermined pattern is received from the flying body, that the flying body is an unauthorized flying body that is not permitted to enter the predetermined area; and
notify a predetermined notification destination of information including the position of the unauthorized flying body.

2. The information provision device according to claim 1, wherein
the flying body to which the mission is given is configured to transmit a signal having the predetermined pattern associated with the mission,
the at least one processor is further configured to execute the instructions to:
in a case where the signal having the predetermined pattern is received from the flying body, determine that the flying body is an authorized flying body permitted to enter the predetermined area; and
notify the predetermined notification destination of information about the flying body determined to be the authorized flying body.

3. The information provision device according to claim 2, wherein
the predetermined pattern is associated in advance individually with the mission of the flying body in the predetermined area, and
the at least one processor is further configured to execute the instructions to
notify the predetermined notification destination of information about the flying body including information about the mission associated with the predetermined pattern of the signal transmitted by the flying body that is determined to be the authorized flying body.

4. The information provision device according to claim 1, wherein
the at least one processor is further configured to execute the instructions to:
receive an identification signal indicating flying body identification information that is an identifier of the flying body, the identification signal being transmitted from the flying body; and
notify the predetermined notification destination of the flying body identification information indicated by the detected identification signal together with position information of the flying body indicated by the flying body identification information.

5. The information provision device according to claim 4, wherein
the at least one processor is further configured to execute the instructions to
determine the flying body indicated by the flying body identification information as the unauthorized flying body in a case where the flying body identification information indicated by the detected identification signal is not included in a working flying body list that is a list of flying body identification information of the flying body to which the mission in the predetermined area is assigned.

6. The information provision device according to claim 1, wherein
the at least one processor is further configured to execute the instructions to
generate, as information about the unauthorized flying body, a display image in which a mark indicating the position of the unauthorized flying body is superimposed on the image of the predetermined area.

7. The information provision device according to claim 6, wherein
the at least one processor is further configured to execute the instructions to
generate the display image in which another mark is superimposed, the another mark being different from the mark of the unauthorized flying body and indicating the position of the flying body that is not the unauthorized flying body.

8. The information provision device according to claim 6, wherein
the image of the predetermined area is a map of an area including the predetermined area or an image obtained by photographing the predetermined area.

9. The information provision device according to claim 1, wherein
the flying body includes a reflection portion in a predetermined shape, the reflection portion reflecting light when being irradiated with light of a predetermined wavelength, and
the at least one processor is further configured to execute the instructions to
detect the reflected light in the predetermined shape as the signal having the predetermined pattern from the image of the flying body irradiated with the light of the predetermined wavelength.

10. A flying body comprising
a specific signal transmission portion that emits a specific signal having a predetermined pattern, the specific signal being associated with a mission in a predetermined area.

11. The flying body according to claim 10, wherein
The specific signal transmission portion is a reflection portion in a predetermined shape that reflects light when being irradiated with light of a predetermined wavelength.

12. The flying body according to claim 10, further comprising
an identification signal transmission part that emits an identification signal indicating flying body identification information, the identification signal being different from the specific signal.

13. An information provision method comprising:
determining whether a flying body is in a predetermined area based on measurement data of the flying body measured by a sensor;
determining whether a signal is received from the flying body that has been determined to be in the predetermined area, the signal having a predetermined pattern associated with a mission in the predetermined area;
determining, if no signal having the predetermined pattern is received from the flying body, that the flying body is an unauthorized flying body that is not permitted to enter the predetermined area; and
notifying a predetermined notification destination of information including a position of the unauthorized flying body.

14. The information provision method according to claim 13, wherein
the flying body to which the mission is given is configured to transmit a signal having the predetermined pattern associated with the mission,
the method further comprising:
determining, in a case where the signal having the predetermined pattern is received from the flying body, that the flying body is an authorized flying body permitted to enter the predetermined area; and
notifying the predetermined notification destination of information about the flying body determined to be the authorized flying body.

15. The information provision method according to claim 14, wherein
the predetermined pattern is associated in advance individually with the mission of the flying body in the predetermined area,
the method further comprising
notifying the predetermined notification destination of information about the flying body including information about the mission associated with the predetermined pattern of the signal transmitted by the flying body that is determined to be the authorized flying body.

16. The information provision method according to claim 13, further comprising:
receiving an identification signal indicating flying body identification information that is an identifier of the flying body, the identification signal being transmitted from the flying body; and
notifying the predetermined notification destination of the flying body identification information indicated by the detected identification signal together with position information of the flying body indicated by the flying body identification information.

17. The information provision method according to claim 16, further comprising
determining the flying body indicated by the flying body identification information as an unauthorized flying body in a case where the flying body identification information indicated by the detected identification signal is not included in a working flying body list that is a list of flying body identification information of the flying body to which the mission in the predetermined area is assigned.

18. The information provision method according to claim 13, further comprising
generating, as information about the unauthorized flying body, a display image in which a mark indicating the position of the unauthorized flying body is superimposed on the image of the predetermined area.

19. The information provision method according to claim 18, further comprising
generating the display image in which another mark is superimposed, the another mark being different from the mark of the unauthorized flying body and indicating the position of the flying body that is not the unauthorized flying body.

20. The information provision method according to claim 18, wherein
the image of the predetermined area is a map of an area including the predetermined area or an image obtained by photographing the predetermined area.

21-30. (canceled)
